(19) United States
(12) Patent Application Publication
(10) Pub. No.: US 2006/0064380 A1
(43) Pub. Date: Mar. 23, 2006

(54) Methods and systems for performing tokenless financial transactions over a transaction network using biometric data

(76) Inventor: Zev Zukerman, San Francisco, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/227,733

(22) Filed: Sep. 14, 2005

Related U.S. Application Data
(63) Continuation-in-part of application No. 10/954,095, filed on Sep. 28, 2004.
(60) Provisional application No. 60/611,069, filed on Sep. 15, 2004.

(51) Int. Cl. G06Q 40/00

(52) U.S. Cl. 705/44; 705/39

(57) ABSTRACT

Systems and methods for performing tokenless financial transactions over a transaction network using biometric data. Financial transactions are completed without tokens, such as credit cards, debit cards, magnetic stripe cards, smart cards, RFID devices, and the like. A customer's identity is authenticated and the transaction is accepted by the customer using biometric information obtained at the point of sale from the customer by means of a point of sale terminal. In preferred embodiments, the customer's biometric information never leaves the point of sale terminal, but, rather, is authenticated over a transaction network in conjunction with a server that holds reference templates of the customer's biometric information, as well as account information. Transactions may be authorized directly by a participating financial institution or indirectly through payment networks such as Visa® and MasterCard®.

### CROSS-REFERENCE TO RELATED APPLICATIONS

This application claims the benefit of Provisional Patent Application Ser. No. 60/611,069, entitled “METHOD FOR ISSUING INSTANT CREDIT AND PERFORMING TOKENLESS BIOMETRIC TRANSACTIONS OVER A BIOMETRIC TRANSACTION NETWORK”, filed Sep. 15, 2004, and is a continuation-in-part of Nonprovisional patent application Ser. No. 10/954,095, entitled “TICKETLESS ENTRY SYSTEM AND METHOD”, filed Sep. 28, 2004, each of which is hereby incorporated herein in its entirety by this reference.

### BACKGROUND

1. Field of the Invention

The invention generally relates to the field of financial transaction processing. Specifically, the invention relates to methods and systems for enabling people to perform such transactions while authenticating themselves or confirming their identity using biometric data, including, but not limited to, by doing so without the use of special physical tokens such as credit cards or badges.

2. Related Art

As is known in the art, payment processing, such as credit card or debit card payment processing, is an elaborate system involving many parties and many roles and responsibilities. The participants in payment processing include an issuing bank, a cardholder, an acceptor or merchant, an acquiring bank, and a payment processor. The issuing bank is the bank or other institution that issues a credit card or debit card to an individual. The cardholder/customer is the individual who is issued a credit card or debit card. The merchant is a business that has qualified to accept credit or debit cards as payment. The acquiring bank is an organization licensed as a member of, for example, Visa® and/or MasterCard®, that maintains a relationship with a merchant and receives all card transactions from the merchant. The payment processor is a third-party organization that provides payment authorization and/or clearing and settlement service on behalf of issuing banks, acquiring banks, and merchants. For example, one of the largest payment processors in the United States is First Data Resources. The payment processor may also be the same as or affiliated with an association such as Visa® or MasterCard®.

The steps involved in credit/debit card payment processing comprise acceptance, authorization, purchase, submission/deposit, settlement, and chargebacks. During the acceptance step, the credit cards and/or debit cards that a merchant can have processed vary according to the specific services that merchant's acquiring bank and payment processor provide. During the typical authorization process, the merchant contacts the payment processor for authorization, typically by “swiping” or reading the magnetic stripe on the card and transmitting the transaction information electronically. The payment processor's data center contacts the card's issuer and retrieves the cardholder's account information. If the card is valid and the cardholder has sufficient funds available, the payment processor authorizes the transaction and returns a numerical approval code to the merchant. If the card is not valid or the cardholder does not have sufficient funds available, for example, if the cardholder is over his credit/debit limit, the payment processor declines the transaction and the merchant asks the customer/cardholder for another form of payment. In some cases, the merchant may be instructed to call the payment processor, if there has been unusual activity on the card or the credit/debit limit is close to being exceeded.

During the purchase step, which occurs after the merchant receives authorization for the purchase, the customer indicates their acceptance of the purchase by signing a sales slip, and the merchant records the sale and issues a sales slip to the customer/cardholder. During the submission and deposit step, the merchant submits daily batches of card transactions to the acquiring bank, either in electronic form or as paper sales slips. The acquiring bank essentially buys the merchant's card transactions and credits their value to the merchant's account, minus a processing fee, which is called the “discount rate.”

During the settlement step, the acquiring bank collects payment for transactions from the issuing banks of each of the individual cardholders. This settlement is carried out through a network of payment processors called “interchange.” Visa® and MasterCard® often perform the role of “interchange”, sometimes in conjunction with or in competition with entities such as First Data Resources. The acquiring bank pays each issuing bank an “interchange fee.” The issuing banks then bill their cardholders for the amount of their charges with an itemized monthly statement, or debit their debit accounts appropriately, again reporting transactions on an itemized monthly statement.

A chargeback occurs when a transaction is challenged by a cardholder or issuing bank and is sent back through interchange to the acquiring bank for resolution. Chargebacks are commonly caused by errors at the point-of-sale, so merchants are best able to minimize chargebacks by preventing them from happening in the first place, as much as possible. On other occasions, chargebacks happen when the customer receives the wrong good. It also happens that some customers fraudulently chargeback a transaction simply because they don't want to pay for the item purchased.

In the past, customers/cardholders who want to make purchases without cash but who instead want to use either a credit or a debit account must undertake the following steps in advance of their first purchases: (1) establish a new line of credit or pre-pay into a specific debit account; and (2) acquire a credit or debit card associated with the specific credit line or debit account. Then, once they are ready to make their purchases, they present the card to the merchant at the point of sale (“POS”), for example, to the sales clerk at the merchant's POS location. They or the sales clerk will then read (“swipe”) their card through a card reader or manually enter the account information from the card. This, in conjunction with the transaction amount, is then commonly sent electronically to a payment processing center to authorize the transaction. If authorized, the customer then signs a transaction confirmation, which is recorded electronically or on paper, which signifies the customer's own acceptance of the transaction. It is often expected that the sales clerk or another employee of the merchant confirms the validity of the customer's signature by inspecting the signature on the card proper and comparing it to the recorded signature.

Once the transaction is completed, often at the end of each business day, the merchant sends the transaction or a batch of all pending transactions to its “acquiring bank” business partner for settlement. The “acquiring bank”, often in conjunction with one or more payment processing “interchange” networks, such as Visas or MasterCard®, then dispatches the transactions to the appropriate “issuing bank” for each transaction. The issuing bank is the bank associated with the customer for each transaction.

The acquiring bank always charges each merchant a fee for each transaction, commonly computed in part on a per-transaction basis, and partly based on the amount of each transaction. The acquiring bank in turn is always charged a fee by the payment processing “interchange” network for facilitating the settlement and clearing of each transaction.

This approach has a number of consequences: (1) the customer must plan, often days or weeks in advance, their need for the creation of and access to the appropriate debit or credit account; (2) the customer must remember to carry their card(s) with them at all times in case they have the need to make a purchase; and (3) the signature, and thus the identity, of the customer is often not, in fact, rigorously authenticated at the point of sale. Even the addition of photographs to some credit cards as a security measure has not helped solve this problem to a significant degree. According to some sources, only 2 in 10 merchants notices a significant discrepancy between the photograph on the card and the face of the customer. Because the card or token holds and displays the customer's account number, this information is readily compromised, either by someone reading the information from the card and noting it down, or from having the information stolen during transmission in the case of online transactions. This fraud adds significantly to the costs of maintaining a credit card network. These costs are borne by the issuers and ultimately passed on to the merchants in terms of higher interchange fees.

Another consequence of the prior credit/debit card payment processing regime is that the card is always tied to one and only one credit or debit account. The customer has no choice or discretion over which of many potentially available accounts is to be used with a given card. This often necessitates the customer carrying many cards to allow flexibility of choice among accounts. In addition, dividing the costs of a purchase across multiple accounts can be difficult or impossible, as the use of two or more separate cards to pay for a single purchase at a merchant location is often prohibited or at least frowned upon.

Recently, the use of biometrics has been added to the payment processing systems and methods described. According to one source, “Biometrics is the science and technology of authentication (i.e. establishing the identity of an individual) by measuring the subject person's physiological or behavioral features.” Example biometrics which can be contemplated for payment systems might include fingerprints, hand structure, retina prints, voice prints, or even LumiGuard™ and LightPrint™.

Some systems have attempted to solve the problems of the customer not remembering to carry their card and of improving identity verification and authentication. In some biometric transaction systems and methods, the token, e.g., a credit or debit card, is linked to a biometric information sample. This linking process is accomplished, for example, by reading (“swiping”) one or more credit cards and then associating these cards to a registered reference biometric information sample.

One example of such a prior art system is provided in U.S. Pat. No. 6,594,376, entitled Tokenless Electronic Transaction System, in the name of Hoffman, et. al. Hoffman describes a centralized system where the transaction is identified, authenticated, and authorized at the central server (FIG. 4). The finger is scanned and the template is extracted at the biometric-enabled POS terminal (FIG. 5). The customer then enters a non-unique account binning number (ABN). This number categorizes the section of the database that contains the customer's registered reference biometric information sample. By sectioning the database, with each bin categorized by an ABN, the system can search a smaller pool of templates when attempting to make a match. After entering the ABN, the customer is then asked to select the payment account they will be using for that transaction. The biometric-enabled POS terminal then sends the candidate biometric information sample, the ABN, and the payment account information to the payment processing center/network operations center (“NOC”) (FIG. 6). The database at the NOC receives the ABN and finds the corresponding bin. It then begins to run a match with every registered reference biometric information sample template in the bin until a successful match is made. Thus, this prior art system must conduct a 1:N search within the bin designated by the ABN. Thus, in all cases, in this prior art system, the biometric must be transmitted to the NOC for this exhaustive search because it is clearly infeasible to transmit the entire bin to the POS terminal. Once the candidate biometric information sample has been authenticated, the selected account information is retrieved, and the transaction is processed. If the transaction is a credit or debit transaction, the account information is sent to the appropriate payment network. Once the payment processing center/NOC receives authorization from that network, the transaction is authorized, and the server sends the authorization back to the biometric-enabled POS terminal.

This centralized system requires excessive transaction processing power because of all the information it necessarily handles to conduct each transaction. The steps of identifying the bin and then matching each registered reference biometric information sample, such as a fingerprint, within the bin until a successful match occurs is can be avoided in a decentralized system. Furthermore, retrieving account information, sending it to the appropriate network, and waiting for authorization burdens the servers even more. The need for extra processing capacity combined with the need for faster processing time raises the costs of the system significantly. This system is inherently inefficient and places a great demand on the performance of the payment processing center/NOC.

Referring to FIG. 4, some of the complexities of a prior art system can be seen. In this prior art system, biometric-enabled POS terminals 401 communicate and clear transactions through a payment processing center/NOC 400. In addition to storing key information needed for identification, as would be expected, NOC 400 must also perform all authentication and authorization as well. This means that all computational load for clearing purchases is concentrated at the NOC. In addition, the inbound communication load on the NOC is increased, as POS terminals 400 must of necessity communicate all candidate biometric information samples to the NOC for authentication.

Referring to FIG. 5, it can be seen that this prior art system requires the user to enter a “binning number” in order to make it possible for the NOC to efficiently search among many possible registered reference biometric information samples at the NOC.

Referring to FIG. 6, it can be seen that this prior art system is inherently inefficient, because it does not simplify the already inefficient system of processing transactions. Instead, it adds a biometric layer on top of an already inefficient system. Hence, it is inefficient to the merchant both in fixed upfront costs (because they have to buy a new biometrically enabled terminal), and in variable costs per transaction because they must pay a fee to use this system in addition to the customary processing, acquiring, and settlement fees for credit card use. In addition, the merchant is required to pay the larger “card not present” interchange fees.

Another example of a related prior art system is provided in U.S. Pat. No. 6,581,042, entitled Tokenless Biometric Electronic Check Transactions, to Pare, Jr. et. al. Pare describes a system which permits the customer to link their checking account information, such as account and routing numbers to a biometric such as the customer's fingerprint. This permits the traditional payment processors and processing fees to be bypassed and instead clears through the standard Automated Clearing House (ACH) mechanisms used for clearing checks. Thus, a cost savings can be achieved because the ACH system has no interchange. However, the problem with these systems is the delay in settlement, or the motion of funds, and thus the delay in payment to the merchant, which can be two to three days, compared to overnight settlement which is common for credit card and debit card payments. In addition, there is the significant risk that an ACH transaction may not clear because of insufficient funds or because the underlying account has been closed. This prior art system can manage such risks, at some expense, by using an outside risk management provider, such as Certegy. Thus, this again increases the per-transaction costs associated with this approach.

There are at least four disadvantages involved in payment processing with credit/debit cards or other tokens. The first disadvantage is that it requires the creation of and the existence of a token or card, such as a credit card. The second disadvantage is that these systems require that the individual's identification be checked to initially authenticate the individual's biometric, as a part of the enrollment or registration process, and the individual must possess a valid token. Typically, this registration process requires having a person physically present to check the individual's identification and the individual cards or tokens when registration takes place. The third disadvantage, ironically, is that the “discount rate” fees paid by merchants for use of these systems are significantly larger than for normal “card-present” transactions, as the payment processor views these improved transactions as higher-risk, even though the identity verification quality is much better. “Card not present” fees are in general charged by the payment processor or credit card association for transactions, such as telephone transactions or internet transactions, where the card is not physically present. In one existing prior art system, the customer's credit card information is captured at enrollment, and presented every time their biometric (e.g., a fingerprint) is scanned to accept a purchase. At each transaction, the merchant pays a “card not present” premium. Thus, the payment processor or credit card association benefit from a more secure transaction at a higher price, at the expense of the merchant. These higher costs for merchants limit commercial acceptance of this prior art system. The fourth disadvantage is that these systems do not scale well as they place the load for each additional merchant and transaction at the central processing site, because these systems are designed to validate the biometric data centrally, rather than at the point of sale location, or the periphery.

In addition, prior credit/debit card payment processing systems all suffer from a disadvantageously high fee structure that can bias some merchants away from offering such transactions at all or force merchants to require a minimum purchase level for their customers. Prior art systems are not capable of tokenless authorization of debit stored value transactions. Prior art systems are very inefficient in their approach to searching for customer records containing selected biometric information. In prior art systems, all authentication of transactions takes place via the payment processing center/NOC. None are capable of performing authentication at the POS terminal. The ability to do so would bring significant improvements in system efficiency and scalability. In order to get merchants to adopt a new system of payment, it is necessary to offer a lower total cost of ownership to the merchants—a notable improvement in transaction cost in return for deploying the new system.

It would be advantageous to authenticate a customer before checking with an issuing bank for authorization. This would offer benefits both in privacy for the customer and in efficiency for the issuing bank. For security reasons, it would be advantageous to eliminate the use and transmission of bank or charge card account numbers within the system.

It also would be advantageous to permit a person/customer the option to instantly apply for and receive a line of credit, or link a debit account that is tied to their ability to make purchases or perform other transactions, and to instantly and reliably validate and authenticate these transactions without requiring a card or other separate authentication token, to rely on a means of validation and authentication that is always with or upon the person of the customer, to use a more reliable and rigorous means of validation and authentication of the customer than has heretofore been offered by traditional credit cards, which have used for example a signature and/or a photograph of the customer, to allow the person/customer to associate in some easy and consistent way with one or many accounts, credit, debit, or otherwise, to allow the customer to choose how to allocate any given purchase across the available accounts, to make it possible to economically offer competitive, flexible, alternative financing and fee structures in the context of such a transaction system, and to design the system so that it scales readily, so that as merchants and transaction load increase, the central system can readily adapt to the increased demand. It would be particularly advantageous to create a system that can easily and rapidly be deployed and used with new customers and new merchants.

### BRIEF SUMMARY

In accordance with preferred embodiments, debit and credit payment transactions are authenticated and processed in a biometrically-enabled payment platform. In a credit card transaction, a customer is authenticated biometrically before an authenticated authorization request is sent to an issuing bank. In a debit card transaction, a customer is authenticated biometrically and a transaction is authorized within the biometric transaction network. A biometric-enabled POS terminal sends the selected credit/debit account and transaction information to the NOC for authorization only after the biometric information is authenticated. This can offer privacy and efficiency advantages. For example, bank account numbers are not transmitted between the biometric-enabled POS terminal and the NOC. Instead, the biometric-enabled POS terminal sends an encrypted credit account classification number that is then matched with the actual bank account number at the NOC. The NOC then checks with that issuing bank for authorization. Hence, even if someone steals the credit account number during its transmission from the biometric-enabled POS terminal to the NOC, the thief would not have the corresponding information to access the actual bank account. Customers are not aware of the credit account classification numbers and are thus not able to generate a transaction from the biometric-enabled POS terminal using those numbers.

Because this system is tokenless, it is possible to create an open system with multiple issuing banks without locking customers and issuers into the mechanics of acquiring, carrying, and using tokens.

Salient aspects of the exemplary embodiments described herein include, but are not limited to:
(1) The UINs (unique ten digit account numbers) are linked to only one set of biometric information samples from each customer, thus simplifying the search for customer records by comparison with prior art systems, which must instead search many sets of registered reference biometric information samples to find an available match to a given candidate biometric information sample;
(2) The ability to retrieve and review account balances before the customer is authenticated. This is an optional capability and may be disabled by some customers or merchants for security reasons;
(3) Authenticating the transaction at the biometric-enabled POS terminal instead of at the payment processing center/NOC. This can result in significant improvements in system scalability and performance;
(4) Transactions can optionally be authenticated at the payment processing center/NOC, thus making it possible to make a lightweight, minimalistic biometric-enabled POS terminal; and
(5) The ability to authorize debit stored value transactions.

### BRIEF DESCRIPTION OF THE DRAWINGS

The foregoing and other advantages will become apparent upon reading the following detailed description and upon reference to the drawings in which:

FIGS. 1A and 1B are flowcharts showing one approach to enrolling or registering a customer/user;

FIG. 2 is a flowchart showing approaches to collecting survey information and granting rewards to customers/users;

FIG. 3 is a system diagram showing how credit can be issued within the system, and how payments can be accepted, authenticated, and made;

FIG. 4 is a diagram of a system wherein all identification, authentication, and authorization are centralized;

FIG. 5 is a flowchart of purchase authorization;

FIG. 6 is a flowchart of the processing within the payment processing center/Network Operations Center (NOC);

FIG. 7 is a diagram of one embodiment in which all authentication and authorization are decentralized;

FIG. 8 is a flowchart of the processing at the Point of Sale (POS) of one embodiment; and

FIG. 9 is a flowchart of the system-wide processing of one embodiment.

### DETAILED DESCRIPTION OF THE PREFERRED EMBODIMENTS

The biometric transaction system is a transaction network that is adapted to process biometric transactions as low-risk transactions. The biometric transactions that are performed are considered low-risk transactions because they may use a combination of an optional token, secret knowledge, and out-of-band authentication for initial customer enrollment, and biometric information obtained from the person of the customer as part of the per-transaction authorization and authentication process. The biometric transaction systems and methods described herein may be used for Authentication, Issuance of Credit, Authorization, and Settlement as described in further detail below.

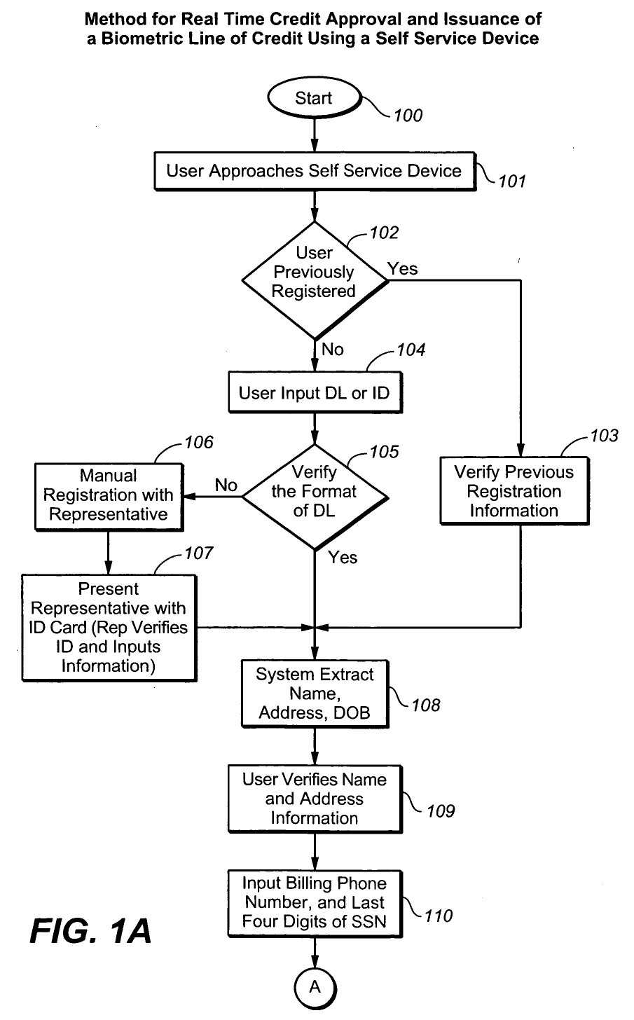

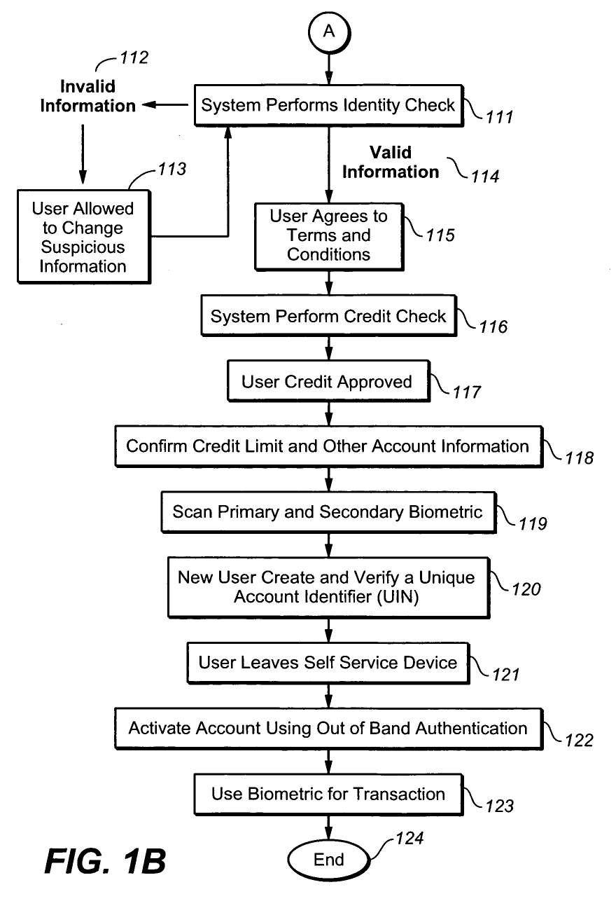

FIG. 1A and FIG. 1B illustrate, among other things, an example for an initial authentication and enrollment process and for issuance of credit within the biometric transaction system. With reference to FIG. 1A, to begin or complete the initial authentication and enrollment process, which serves to complete the registration of the customer or user within the system, the customer approaches the self-service device at 101. The self-service device may be a standalone kiosk purpose-built to facilitate registration of customers, or it may be an aspect of a biometric-enabled point of sale (POS) terminal. At 102, the system determines whether or not the customer has been previously registered with the system. This will be achieved by communicating to the payment processing center/NOC to query the customer database. If the customer has been previously registered, the system verifies the previously entered registration information, and proceeds to 108. If the customer has not been previously registered, then at 104 the customer will input their Driver's License information (DL) or other (ID) identifying information. At 105, the system verifies the format of the DL or ID information, and perhaps also verifies the validity of same. Should such verification fail, then at 106, the customer interacts with a person—for example, a customer service representative—who can confirm the user's identity and other information and manually enter same into the system at 107, and then proceed to 108. If the verification at 105 succeeds, then the process proceeds to 108. At 108, the system extracts the customer's Name, Address, and Date of Birth (DOB) from its records. The customer at 109 verifies the name and address information, then, at 110, inputs their billing telephone number and the last four digits of their Social Security Number (SSN). The process then continues to 111 on FIG. 1B.

Referring now to FIG. 1B, at 111, the system performs an identity check on the customer. Should this fail, the system reports “Invalid Information” at 112, and at 113, the customer is granted the opportunity to change or correct inaccurate or incorrect information. At 114, the system has valid customer information, and proceeds to 115, where the customer confirms their agreement to the requisite terms and conditions. The system then performs a credit check on the customer (116), requests and obtains credit approval for the customer (117), and confirms credit limit and other account information (118). Then, at 119, primary and optionally secondary reference biometric information samples are obtained from the customer's person. At 120, the new customer creates and verifies a Unique Identification Number (UIN) for themselves, and leaves the self-service device (121). The account is then activated using out of band authentication (122) as described in more detail below. Thereafter, the customer can use their biometric information for one or more transactions (123).

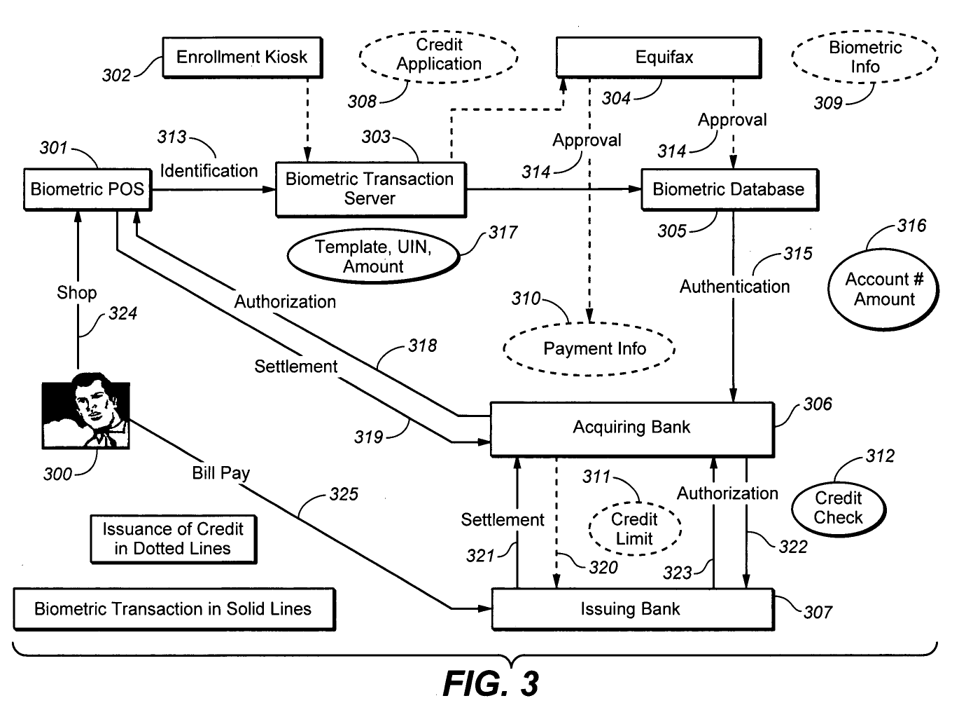

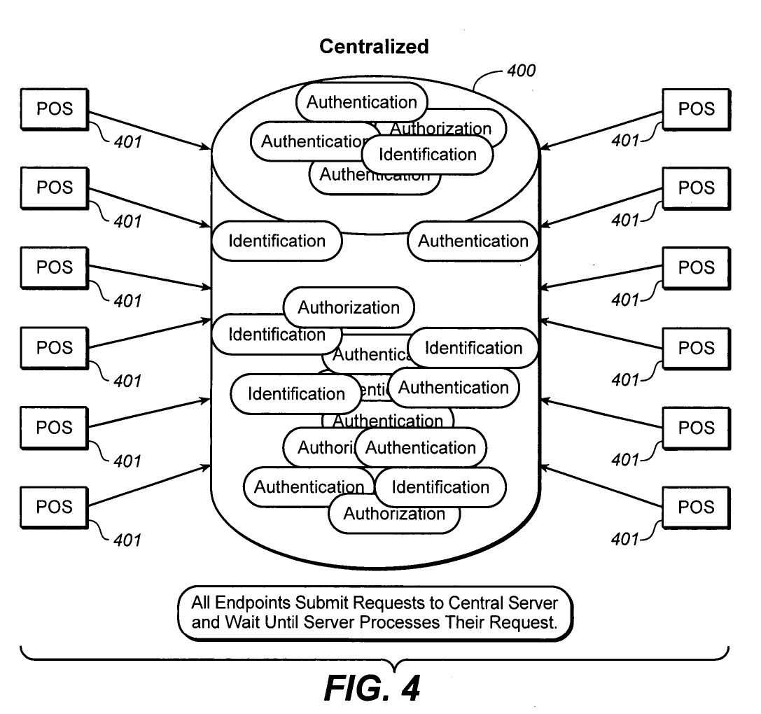

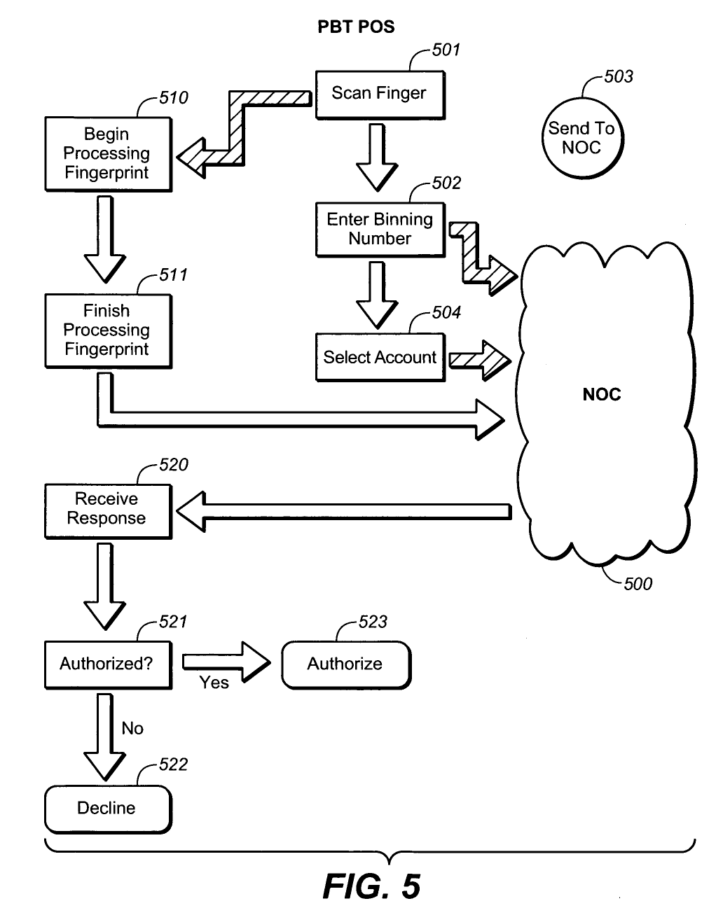

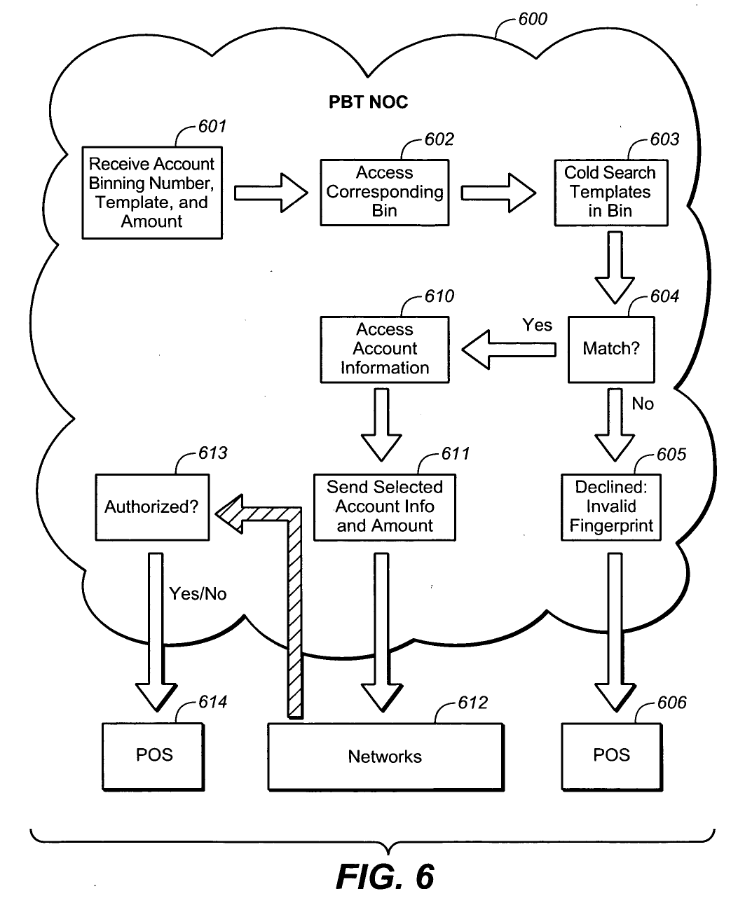

With reference to FIG. 3, the customer 300 can perform the step 324 of shopping at a merchant by using the biometric-enabled POS terminal 301 installed at the merchant's location. This assumes either that the customer has completed enrollment proper through some biometric-enabled POS terminal at some merchant location, or that they have completed enrollment through enrollment kiosk 302. Enrollment through kiosk 302 proceeds through the biometric transaction server 303 at the payment processing center/Network Operations Center (NOC) of the system, by sending a credit application 308 from the enrollment kiosk through biometric transaction server 303 to a credit agency 304 such as Equifax. If and when approval 314 is received from credit agency 304, the new credit account is recorded in the biometric database 305, along with customer reference biometric information 309. Approval 314 is also associated with credit account payment information 310 which is made available for authorized payments to the acquiring bank 306 which facilitates the merchant's settlement processes. When customer 300 makes a purchase through biometric-enabled POS terminal 301, the customer's UIN 313 is sent to biometric transaction server 303, which in conjunction with the biometric database 305 is thus able to retrieve information 317 such as the reference biometric information sample template and account information such as the amount of available credit for this customer. This information is made available to the biometric-enabled POS terminal 301, which, upon confirming the customer's identity by successfully comparing the reference information with the biometric information sample obtained from the customer's person, passes the confirmed authentication to biometric transaction server 303, then through the biometric database 305 which also keeps backup records of all transactions on to the acquiring bank 306, which may perform a credit check 312, but in any event obtains authorization through authorization request 322 and authorization reply 323 from issuing bank 307, which may also evaluate the customer's credit limit 311. Upon successful authorization to acquiring bank 306, it sends the authorization on to biometric-enabled POS terminal 301, which can then confirm to the merchant that the merchant will be paid for this transaction and that the sale may proceed to completion. Later, at settlement time, settlement requests 319 are sent by biometric-enabled POS terminal 301 on behalf of the merchant to acquiring bank 306, which then relays a settlement request 320 to issuing bank 307, which then completes settlement by transferring funds at 321. Eventually, the customer pays their bill at 325, thus completing the funding of settlement transaction 321.

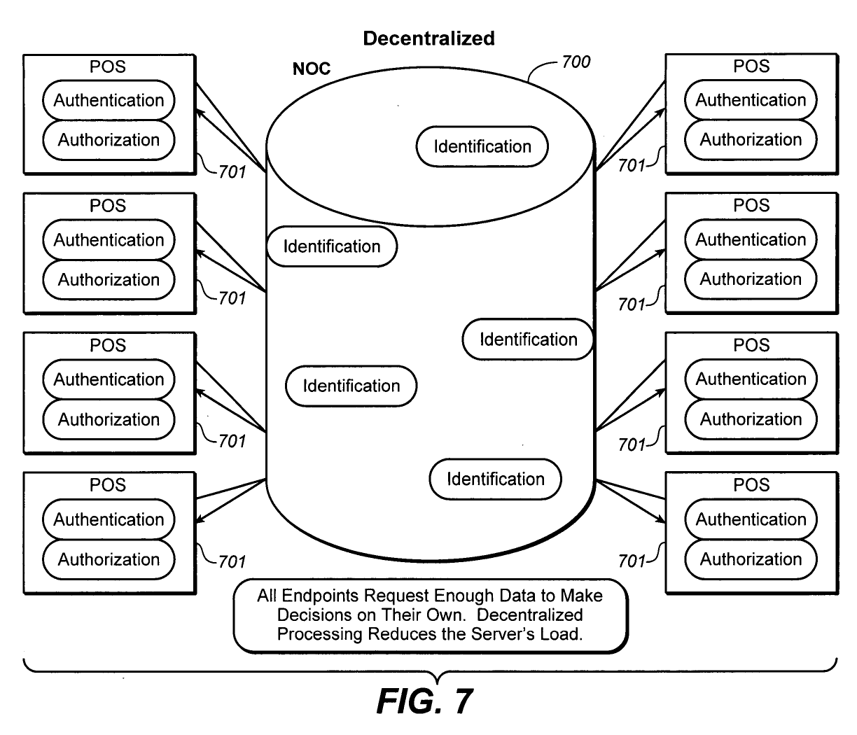

Referring to FIG. 7, biometric-enabled POS terminals 701 communicate with payment processing center/Network Operations Center (NOC) 700. While the NOC is responsible for storing and maintaining key information needed for identification, all authentication and debit authorization is in fact performed at the biometric-enabled POS terminals, thus offloading the NOC. In terms of credit transactions, authorization still happens at the issuing bank. The biometric-enabled POS terminal shown here is novel and invaluable in that it supports a system that can link multiple lines of credit to just one customer and account. Hence when that account is accessed the POS terminal displays all possible credit accounts and only initiates an authorization request once the payor has been authenticated. Thus, here the POS terminal is novel in that it permits the customer to instantly choose what credit account to use for a given purchase, and thus which credit account to authorize this transaction against. This is a significant improvement over any token based prior system, as well as over any biometric prior art system. In addition, since many data communications systems, such as Asymmetric Digital Subscriber Lines (ADSL), often have better performance from the NOC towards the biometric-enabled POS terminals than in the reverse direction, the volume of information sent from the biometric-enabled POS terminals to the NOC is minimized, as the NOC sends reference biometric information sample templates to the biometric-enabled POS terminals for their comparison and authentication.

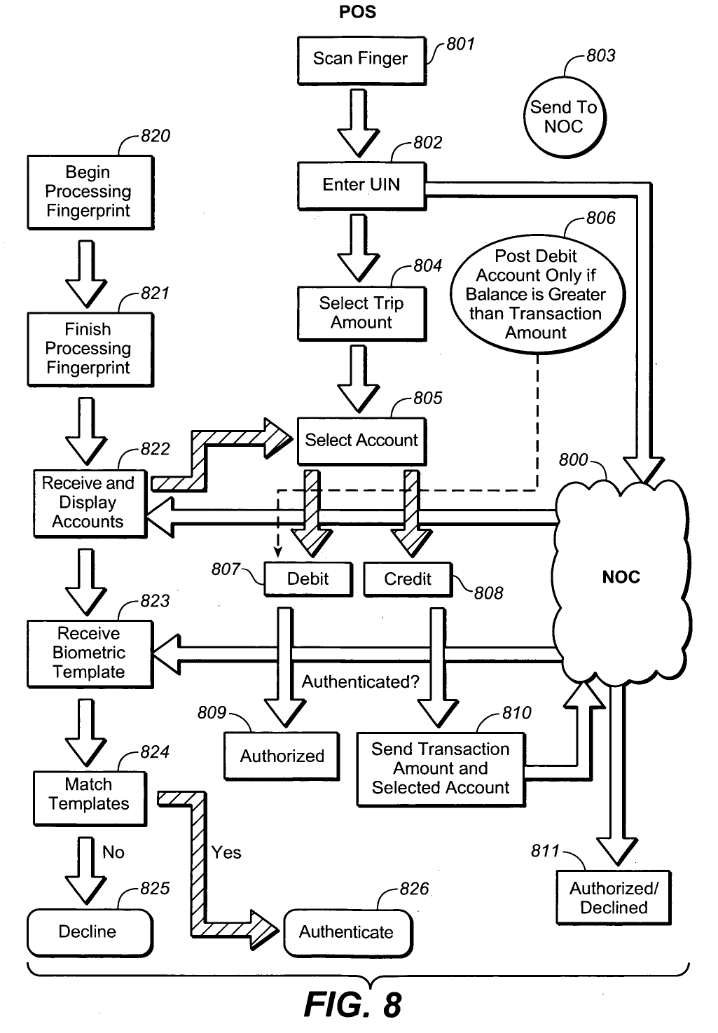

Referring now to FIG. 8, having selected their purchase, the customer elects to pay for the purchase through the biometric transaction system. The customer initially submits a candidate biometric information sample, which is obtained from their person, such as a scanned fingerprint, to the biometric-enabled POS terminal at 801. Things may now proceed in parallel, to some degree. On one path, the customer then enters their Unique Identification Number (UIN) at 802, which is sent to the payment processing center/Network Operations Center (NOC) 800 at 803. The customer may then optionally select the tip amount for the transaction at 804. Meanwhile, the POS terminal starts and finishes processing the fingerprint (820, 821). The NOC, once it receives the UIN, sends the account information to the POS terminal, which is received at 822. The POS terminal then displays the account information to the customer, who can then select the preferred account for this purchase at 805. The NOC also sends the reference biometric information sample template for this customer to the POS terminal, which is received at 823. The POS terminal then matches the received template with the template derived from the candidate biometric information sample (824). If they match, the transaction is deemed accepted and authenticated (826). If they do not match, then the POS terminal asks the customer to re-scan their finger while the POS sends a request to the NOC for that UIN's registered secondary reference biometric information sample template. The re-scanned candidate biometric information sample and the primary registered reference biometric information sample template are re-matched. If this fails, then the re-scanned candidate biometric information sample and the secondary registered reference biometric information sample template are matched. If there is still a failure, then the transaction is declined (825). The customer has by now selected which account, which may then determine whether a debit account 807 or credit account 808 has been chosen. Assuming that the transaction has by now been authenticated 826 within the POS terminal, the transaction is then deemed accepted and authorized (809) in the case of a debit transaction, or it is necessary to authorize the credit transaction with the issuing bank by way of the NOC 800. Thus, at 810, the transaction amount and selected credit account information is sent on to the NOC, for forwarding to the respective issuing bank, which, at 811, will either authorize or decline the transaction. In either event, the issuing bank will respond to the POS terminal to indicate its decision.

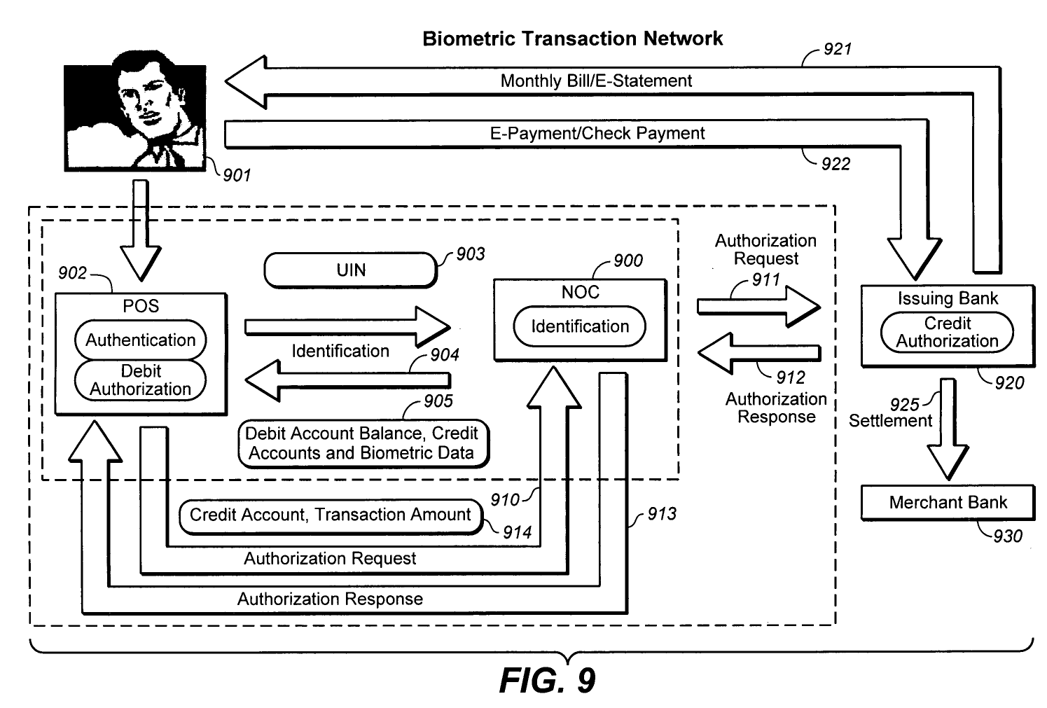

With reference to FIG. 9, customer 901 selects an item to purchase and wishes to pay for the item using the merchant's biometric-enabled POS terminal 902. POS terminal 902 sends identification 904 in the form of the customer's UIN 903 to the payment processing center/NOC 900, which then returns information 905 including the customer's debit account balance, reference information for the customer's credit accounts, and the registered reference biometric information sample template for this customer. For a debit transaction, the balance of the authentication and authorization decision can now be made at the POS terminal as described above with reference to FIG. 8. For a credit transaction, POS terminal 902 now sends an authorization request 910 containing information including a reference to the selected credit account and the transaction amount to NOC 900. NOC 900 then forms an authorization request 911 to the issuing bank 920, which in turn sends authorization response 912 back to the NOC. This authorization response is then relayed at 913 back to POS terminal 902. Assuming that the transaction is thus authorized, the customer can complete the purchase with merchant. Of course, if the transaction is declined, the customer may choose another account within the biometric transaction system or some other means of payment outside the system. Later, issuing bank 920 can complete settlement payments 925 to the merchant's bank 930. Also, a statement 921 such as a monthly bill or e-statement can be sent to customer 901, and the customer can make payment 922, for example, through an e-payment or check payment.

Authentication

Authentication is the act of proving someone or something as trustworthy or genuine. Authentication is often accomplished by presenting proof of identity using a driver's license and/or by having a credit card or debit card. The customer/consumer authentication process here is similar to the authentication process described in related patent application Ser. No. 10/954,095, entitled “TICKETLESS ENTRY SYSTEM AND METHOD”. An illustrative initial authentication/customer enrollment is described in further detail in the attached flowchart and described in detail above with reference to FIGS. 1A and 1B.

During the initial authentication process a token, secret knowledge, and out-of-band authentication are employed. As used herein, a token is a credit card, a debit card, a magnetic stripe card, a smart card, or any such instrument that is used to perform a transaction. Assuming that fundamental biometric information is already available for a person in a trustworthy way, such information can be used instead of, or in conjunction with, such a token. Secret knowledge is knowledge that is secret to the individual who has a token. For example, secret knowledge includes a social security number, the middle name of one's mother, the name of a favorite teacher, and any other knowledge that is not in the public domain and is particular to the individual. Out-of-band authentication provides an “out-of-band” pathway separate from the client network, usually a cell phone or personal digital assistant (PDA) to which an SMS (Short Messaging Service) or text message can be sent, a home phone and/or a voice-authentication system, for verifying the credentials of on-line banking or e-commerce customers. There are various kinds of out-of-band authentication methods. In a first illustrative method, after an on-line user inputs his user name, his home phone rings and his voice is authenticated by computer and account access is then granted. Another illustrative method uses “soft certificates,” or digital certificates installed on smart cards or on the Web browser of the customer's personal computer.

Issuance of Credit

After the customer is initially authenticated and enrolled, the biometric transaction network permits an individual to use the authenticated personal information to register or enroll for credit within the biometric transaction network. Due in part to the out-of-band authentication process, the enrollment in the system and use of a credit or debit account can be accomplished without the need for another person's physical presence to authenticated the biometric and the identification card. The issuance of credit may be performed without the use of a token such as a credit card, debit card, or smart card. For example, a customer can initially authenticate themselves on-line, and complete their enrollment at a transaction kiosk, or at any point of sale. In either case, for the customer's very first transaction with the system (the “enrollment transaction”), the customer can optionally provide a token, but can also provide a unique enrollment identifier which is used to help link their biometric information with their account as well as to complement the balance of the initial authentication process.

In operation, the customer provides personal information as described above. This personal information is then submitted to a credit agency, perhaps in conjunction with business partners standing in a role similar to that of issuing banks for standard credit cards. Once the credit agency runs the credit check, it will return a score which when provided to the system for issuing credit will determine whether or not the customer will be approved for credit and, if so, for how much. If the individual/customer obtains credit approval, the biometric information is linked to the new credit account, or the new credit account is set up to link the individual's biometric information on the first transaction as described above. In the illustrative example, during the issuance of credit a credit account number maps to the registered consumer's biometric information. Of course, the customer may in the alternative opt to set up one or more debit accounts, or combine debit and credit accounts as appropriate to their own needs.

Acceptance and Authorization

As used herein, acceptance is the act of having a customer grant permission for a transaction. In the prior art, acceptance is achieved by having the customer produce a signature on a credit or debit card transaction.

As used herein, authorization is the act of requesting confirmation from the issuing bank that the transaction and transaction amount are permitted, and that they would be paid if the customer completes the transaction with an acceptance. Authorization in classic credit and debit card systems is typically achieved wherein the merchant's point-of-sale system contacts the issuing bank by way of the payment processor, such as, for example, the Visa® payment processing network. Authorization requests are commonly performed in real time for each individual transaction, with an approval, referral, or denial response returned in a matter of seconds. Since most authorization requests are approved, the term “authorized” is frequently used to refer to transactions that have been approved through the authorization process.

Once the transaction has been authorized, and the customer commits to the purchase, the merchant is permitted to settle the transaction by presenting the appropriate records to its acquiring bank for payment. The customer conducts a transaction by accessing a merchant's biometric-enabled POS terminal. The biometric-enabled POS terminal is configured to communicate with the biometric transaction network. The customer's biometric information and possibly a unique code is used to identify the customer's account or accounts regardless of whether or not the individual has sufficient credit.

In the biometric transaction network, the illustrative POS terminals are independent of existing POS terminals and would not integrate in any way with existing payment processing networks, such as Visa® or MasterCard®. During the transaction, the biometric information acts as the authentication mechanism in communication with an acquiring bank that is configured to process biometric transactions. The biometric information is processed in a manner that is substantially similar to an acceptance or a signature in a credit card or ATM transaction. In a sense, the biometric information plays two roles in the biometric transaction network—on the one hand, it is used initially to authenticate the user and to provide the needed reference information to authorize the transaction; on the other hand, it serves as a part of the necessary transaction record to reflect the customer's acceptance, as described above. In the illustrative embodiment, the biometric-enabled acquiring bank would then charge an interchange fee for the transaction, and it would bear all the risk for fraudulent transactions.

For example, in a closed loop network, similar to the American Express card payment processing transaction network, the biometric-enabled POS terminal communicates with a biometric-enabled acquiring bank. Once authorization for the transaction has been requested by the merchant and returned to the merchant by the acquiring bank, the acquiring bank completes the settlement process with the merchant using well known prior art methods. For such a closed loop network, the acquiring bank is also the issuing bank, so the authorization and settlement step between the acquiring bank and the issuing bank is not necessary.

In an alternative open loop network, similar to the Visa® payment processing transaction network, the merchant's biometric-enabled POS terminal communicates with the acquiring bank which then settles the transactions. The acquiring bank then communicates with the issuing bank using the open loop network. The issuing bank and acquiring bank proceed to conduct their respective authorization and settlement, and the issuing bank proceeds to bill the customer.

An illustrative example of a method for tokenless authorization of an electronic payment between a customer and merchant uses a biometric-enabled POS terminal as an electronic identity-confirming device, and at least one customer biometric information sample follows. The method comprises a customer authentication and registration/enrollment step as described above. The customer then creates a new credit (or debit) account by using a kiosk to input personal information and authorize a credit check, or to link to an existing debit account such as a checking account. Once the customer receives credit or debit approval, the customer registers a unique identification number (UIN) and at least one reference biometric information sample. The unique identifier acts as a reference number for the biometric information sample which is stored for reference in the biometric database. Once the account is created, the customer has the ability to access their line of credit, or their debit account, by submitting appropriate biometric information alone or biometric information and the UIN.

The authentication and authorization is performed when the customer's registered reference biometric information sample is electronically forwarded to the electronic identity-confirming device, which may, for example, be integrated with the biometric-enabled POS terminal at the merchant. The newly-collected customer candidate biometric information sample is compared with at least one registered reference biometric information sample to produce either a successful or failed identification and authentication of the customer. Once the device successfully identifies the customer, the customer's previously registered credit/debit account is retrieved and a biometric based authorization of an electronic payment is issued without the customer presenting any personalized man-made tokens such as a charge card, debit card, other magnetic stripe card, or smart card. In the illustrative embodiment, the customer's credit/debit account is thus accessible via the biometric transaction network. Funds are transferred from the customer's credit issuing bank or debit account to a merchant financial account via the acquiring bank.

In this system, each account number has only one set of biometric templates associated with it. Thus, the NOC can transmit the customer's registered reference biometric information sample template to the POS terminal for authentication. Hence, the candidate biometric information sample never leaves the POS terminal.

Settlement

Settlement is the process by which authorized transactions are submitted to card issuing banks for payment. Unlike authorization, which is typically performed in real time, settlement is a batch process. Prior to settlement, payment information for authorized transactions is “captured” to create a settlement record for each authorized (and “purchase committed”) transaction.

The banking transaction may occur by having the acquiring bank send a request to the issuing bank to electronically transfer to each merchant account the amount of money owed to that merchant. The money moves using an electronic funds transfer, with the acquiring bank using its own internal systems and methods to conduct and manage transactions. For open loop network transactions, the issuing bank would then be responsible for billing the customer by mail. In the illustrative example, the customer would then send payment to the bank in the form of a check to pay off the debt.

As is known in the prior art, it is beneficial to permit the customer also to link their biometric information with their checking account. To improve upon the limitations of the prior art, and thus dramatically reduce the transaction costs associated with this approach, this system permits the customer to pre-fund a debit account within the system by authorizing the direct transfer of funds from their checking account into such a debit account.

To overcome the possibility that funds may not be available because such pre-funded funds have not yet arrived in the customer's debit account, this system takes advantage of its unique access to the customer's lines of credit. Unlike any known prior art, this system supports the customer's lines of credit on the same payment platform as the customer's debit account(s). Hence, if the customer has an existing line of credit in the system, the system can arrange to float the stored value in the debit account to the customer while the customer's funds are being transferred via ACH. The system will reserve/block out the amount being transferred on the customer's credit line and hold it until the funds are received into the debit account. Thus, to the customer it seems as if the funds have been transferred instantly to their debit account and that they are therefore allowed to instantly conduct transactions. In reality, the system funds any transactions conducted while the funds are being transferred to the customer's credit line. If the funds do not successfully transfer for any reason, the system will automatically freeze the customer's debit account and deduct any purchases already completed from the customer's line of credit.

This combination of debiting transactions internally using stored value eliminates the per-transaction ACH costs as well as the costs of insuring transactions. This allows this system to facilitate the same type of debit transactions using the ACH network (instead of traditional credit card payment processors) at a much lower transaction cost than known prior art systems.

This approach of debiting, for example, a checking account, electronically, while reserving against a credit line until funds are actually received can be useful not only at the time of initial enrollment, but at any time when the customer wishes to draw upon their debit account but sufficient funds are not available. Thus, for example, the customer might be told by the POS terminal that sufficient funds were not available in a debit account, and given the option to authorize a direct transfer from their checking account to their debit account. The system could then approve the purchase based on the system's ability to reserve adequate funds from one or more of the customer's credit lines in advance of the receipt of funds in the debit account.

Permission Advertising and Reward Claim Method

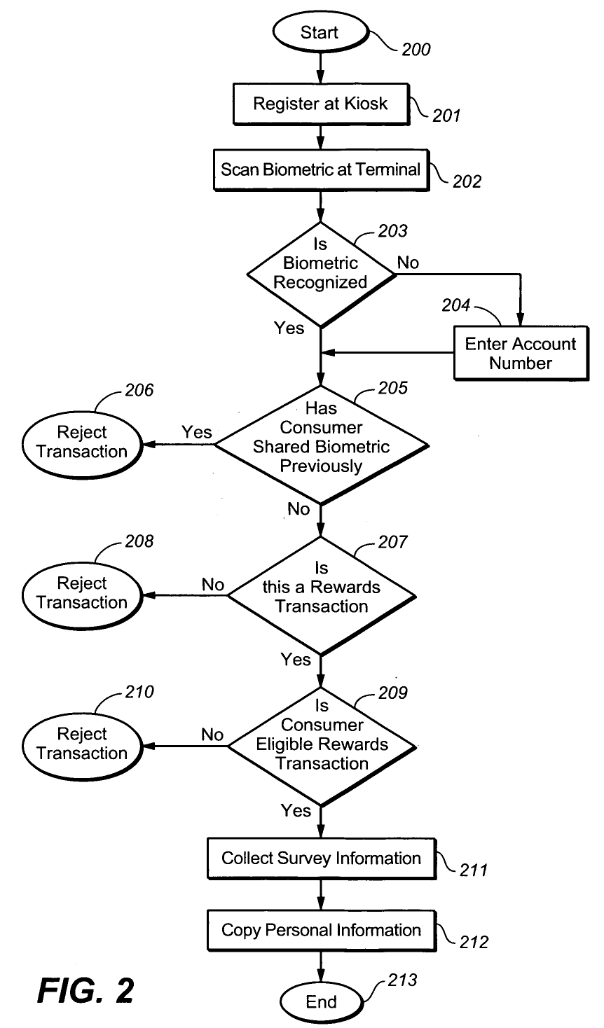

Referring to FIG. 2, permission advertising is related to the submission of personal information using only biometric information such as a fingerprint. The biometric information acts as authorization to share the customer's information with a vendor or merchant that is interested in selling the customer products or services. The biometric transaction network may permit the customer to authorize the sharing of personal information by simply providing biometric information.

Biometric information, such as a fingerprint, is submitted to a standard fingerprint scanner or other appropriate biometric-enabled device which then allows the release of information such as name, address, phone number, and e-mail address. Alternatively, the customer may place his or her finger on a scanner and then answer a few questions on the touch screen, thus submitting both personal and survey information.

The biometric transaction network can be used for a rewards program in which a customer's past habits are tracked to determine whether they are entitled to a reward. In an illustrative example, the San Francisco Giants may make an offer in which, after a customer attends 10 games in one season, the customer is awarded with a Barry Bonds bat.

Additionally, the biometric transaction network permits a customer to approach a biometric-enabled POS terminal or kiosk, provide biometric information and a unique identifier, and have the database access their attendance information.

Other applications for the private biometric transaction network may include, but are not limited to, permitting customers to make multiple submissions to receive extra prizes, or to increase their chance of winning a prize in case of a drawing. Further still, customers may be categorized based on spending or attendance history.

The above systems and methods permit limited use of human resources in repeated data entry.

### EXAMPLE #1

Referring to FIG. 3, the issuance of credit is initiated at an enrollment kiosk that is biometric-enabled. The enrollment kiosk receives personal information and biometric information from the customer and submits this information to a biometric transaction server. A subset of the collected information is submitted as a credit inquiry to an agency such as Equifax using XML or another such mark-up language. The biometric information is then submitted to the biometric transaction server and stored for reference on a biometric database.

After the credit agency processes the credit inquiry, the results are submitted to the biometric transaction network and the credit inquiry results are also stored for reference within the biometric database. Additionally, the credit inquiry results are communicated to an acquiring bank. The acquiring bank subsequently communicates this credit inquiry information to an issuing bank that is charged with providing and managing the customer's credit line.

An illustrative biometric transaction is also depicted in FIG. 3. In the biometric transaction a customer interfaces with a biometric-enabled POS terminal. The biometric-enabled POS terminal is communicatively coupled to the payment processing center/NOC/biometric transaction server and authenticates the customer by accessing biometric databases through the biometric transaction server. The customer is authenticated using the biometric information and a unique identification number (UIN). The customer makes an acceptance for the transaction amount, and the transaction is authorized. The results of the authentication, authorization, and acceptance are then communicated to the acquiring bank.

After authentication and acceptance, the method proceeds to perform the authorization and settlement between the merchant and the acquiring bank. Note, in this exemplary embodiment, the acquiring bank is able to communicate directly with the authentication component, and the acquiring bank and the authentication components are both elements of the biometric transaction network.

The acquiring bank then proceeds to perform an authorization and settlement transaction with the issuing bank. The issuing bank then submits a bill to the customer for payment.

### EXAMPLE #2

Another exemplary embodiment is comprised of two main components. The first is at least one payment processing center/network operations center (NOC). This center houses the system's processing servers, which will use a database, e.g., an Oracle database, to store, e.g., biometric information, account information, and transaction information. The second component is the system's satellite stations (which are referred to as point-of-sale (POS) terminals) that are located at participating merchants. Each biometric-enabled POS terminal station is comprised of a touch screen POS terminal, a biometric information reader such as a fingerprint reader, and a computer. The customer uses a satellite station when conducting a tokenless transaction. Each satellite station communicates with the NOC using a networking protocol, e.g., TCP/IP.

At the biometric-enabled POS terminal, the first step comprises of a customer submitting a candidate biometric information sample, such as a fingerprint. (FIG. 8). Once the biometric information is scanned the terminal begins processing the fingerprint by first extracting the template from the fingerprint image. By scanning a candidate biometric information sample first, the customer is giving the system the maximum amount of time to extract the template. While the template is being extracted, the customer will then prompted on the terminal screen to enter in their unique ten-digit identification number (UIN). The UIN is only used for identification and will be sent to the database immediately after it is entered. After the account number screen, the customer may be prompted for a tip amount screen. This screen is optional and will appear for terminals located for merchants like Starbucks, Quiznos, etc. This feature will allow customers to add a tip to the total transaction amount. This is more convenient than writing it on the receipt and should result in greater tip amounts to employees. Most importantly, the screen buys the system time by keeping the customer busy, while their account information is being retrieved at the NOC (FIG. 8).

Account information is comprised of the customer's: List of credit accounts, perhaps a debit account with a stored value balance, and biometric information. For each transaction, when a UIN is entered it is sent to the NOC and the identity management system is then accessed. The identity management system consists of customer files that store personal account information, including contact information, reference biometric information, and list of credit accounts and/or debit accounts with their available stored value balances. That file is then sent to the biometric-enabled POS terminal for processing.

When the biometric-enabled POS terminal receives the file, it displays the accounts in that file for the customer. The terminal will automatically display any credit accounts but will only display a debit account if the balance on the debit account is greater than the transaction amount. There is also the alternative scenario of having the system display the debit account automatically for every transaction and only if the customer selects will it then check that the account balance is sufficient against the transaction amount. At this point, the transaction has not yet been authorized, nor yet accepted by the customer.

While the customer is selecting which account to use, the biometric-enabled POS terminal matches the registered reference biometric information sample with the candidate biometric information sample. If the match is successful then the biometric-enabled POS terminal continues to process the transaction.

Here there are two types of scenarios:

A. Debit account selected: If a debit account is selected, the transaction is authorized instantly at the biometric-enabled POS terminal, because the available balance was greater than the transaction amount and the customer is authenticated. Of course, the system is designed to eliminate opportunities for fraudulent spending that might arise were a customer to try to perform two transactions at nearly the same time at two adjacent terminals. Thus, for debit accounts, settlement may optionally be initiated immediately upon acceptance by the customer.

B. Credit account selected: If a credit account is selected, then the biometric-enabled POS terminal creates a new file comprising of the selected credit account and transaction amount information that is sent back to the NOC. This is sent to the credit transaction processing system, which runs on a server that switches the transaction to the issuing bank for authorization. As soon as an authorization decision is received back from the issuing bank, this server sends it back to the biometric-enabled POS terminal.

If there is no match, the system will give the customer one chance to rescan their primary biometric. As soon as the customer is asked to re-scan the primary biometric, the POS terminal will retrieve the secondary registered reference biometric information sample template from the database via the NOC. Hence, if the primary biometric information is not matched the second time, the secondary biometric will have arrived at the POS terminal and is instantly available to be matched against the customer's proffered secondary biometric information sample. This will significantly reduce wait time. If there is still no match, (between the second candidate biometric information sample and the second registered reference biometric information sample) the transaction will be declined and the system will reset. After the transaction is authorized and accepted, and the customer leaves the biometric-enabled POS terminal, the system will settle the transaction by sending the transaction details to the settlement server, which will commit the transaction to the database. Of course, the system is designed to eliminate opportunities for error that might arise from a communications networking failure or a database failure.

### EXAMPLE #3

In this exemplary embodiment, each satellite biometric-enabled POS terminal authenticates its own transactions, thereby reducing the load on the central servers at the payment processing facility/NOC. (FIG. 7).

This example leverages the processing power of the computer within the satellite biometric-enabled POS terminal. The computer does three things: extracts the template from the candidate biometric information, matches the candidate template with the received registered reference biometric information sample template, and supports some of the business logic such as displaying accounts with available balances greater than the transaction amount. By requiring a minimal amount of processing work from the central server, the overall system will be capable of handling many more transactions per minute than a purely centralized system of the same capacity, where all the work is done centrally.

The biometric-enabled POS terminal is enabled to instantly authenticate a customer using their biometric information without having the candidate biometric information leave the terminal. This is done with a UIN that is sent to the NOC and thus retrieves the associated customer account information. In addition, the process of authorization of a debit stored value transaction is decentralized. This would happen, for example, if a customer opens and funds a debit stored value account. He then is able to select that account when conducting a purchase and the biometric-enabled POS terminal will authorize the transaction instantly if the customer has been authenticated and adequate funds are available.

The acceptance process permits the customer to choose how to allocate the transaction across one or more available accounts. In the simplest case, the customer has only one account available, in which instance no account choices are presented to the customer. In the next case, the customer can select one of a number of available accounts for use. At the option of the customer, the customer can even allocate spending among multiple accounts for a given transaction.

### EXAMPLE #4

In another exemplary embodiment, a method and system for tokenless authorization of commercial transactions between a customer and a merchant uses a decentralized computer system. The method comprises the steps of registering a customer, wherein the customer registers with the computer system a unique identification number (UIN), at least one registration biometric information sample, and at least one customer financial account. The method also includes a merchant registration step, wherein the merchant registers with the computer system at least one merchant financial account. In a proposal step, the merchant offers a proposed commercial transaction to the customer usually comprising price information. If the customer accepts the merchant's proposal, in an acceptance step, the customer signals his/her acceptance by adding to the proposed commercial transaction the customer's personal authentication information comprising their UIN and at least one candidate biometric information sample which is obtained from the customer's person. In a transmission step, only the UIN is transmitted to the payment processing computer system. The candidate biometric information does not leave the biometric-enabled POS terminal. The transaction amount does not leave the biometric-enabled POS terminal until the customer accepts the transaction. The payment processing computer system then locates that UIN's corresponding account information and transmits the registered reference biometric information sample and any account information back to the biometric-enabled POS terminal. At the biometric-enabled POS terminal, the system compares the candidate biometric information sample with the registered reference biometric information sample for producing either a successful or failed identification and authentication of the customer in a customer identification step. Upon determination of sufficient financial resources, and acceptance by the customer, a financial account of the customer is debited and a financial account of the merchant is credited, in a payment step. Therefore, a commercial transaction is conducted without the customers having to use any portable man-made devices or tokens such as credit cards, magnetic stripe cards, or smartcards.

### EXAMPLE #5

In another exemplary embodiment, a method and device for tokenless authorization of an electronic payment between a customer and a merchant uses a biometric-enabled POS terminal as an electronic identity-confirming device and at least one customer candidate biometric information sample.

The method comprises a customer registration step, wherein the customer registers with a biometric-enabled POS terminal at least one registered reference biometric information sample, at least one customer credit/debit account, and a customer unique identification number (UIN). An electronic financial transaction is formed between the customer and the merchant, comprising at least one customer candidate biometric information sample, wherein the candidate biometric information sample is obtained from the customer's person, in a transaction formation step. In at least one transmission step, the customer's UIN is electronically forwarded to the payment processing center/NOC. The NOC retrieves that UIN's account information comprising of account balance and a registered reference biometric information sample and sends it back to the biometric-enabled POS terminal. A comparator engine compares the candidate biometric information sample with at least one registered reference biometric information sample for producing either a successful or failed identification and authentication of the customer. Once the device successfully authenticates the customer, the customer's previously registered credit/debit account data is retrieved and a biometric-based authorization of an electronic payment is issued without the customer presenting any personalized man-made tokens such as credit cards, magnetic stripe cards or smartcards to transfer funds from the customer's financial credit/debit account to a merchant financial account.

### EXAMPLE #6

In another exemplary embodiment, a method and device for tokenless authorization of a stored value transaction between a customer and a merchant uses a biometric-enabled POS terminal as an electronic identity-confirming device and at least one customer candidate biometric information sample. The method comprises the steps of registering with a biometric-enabled POS terminal at least one registered reference biometric information sample, a customer unique account identification number (UIN), and at least one customer stored value account.

In a transaction formation step, an electronic financial transaction is formed between the customer and the merchant, which includes a customer's UIN, a transaction amount, and at least one customer candidate biometric information sample where the candidate biometric information sample is obtained from the customer's person. In at least one transmission step, the customer's UIN is electronically forwarded to the payment processing center/NOC. In a customer identification step, the NOC then locates that UIN's corresponding account information and transmits the registered reference biometric information sample and any account information back to the biometric-enabled POS terminal. In a customer authentication step, the biometric-enabled POS terminal compares the candidate biometric information sample with at least one registered reference biometric information sample for producing either a successful or failed authentication of the customer. Upon successful authentication of the customer, a stored value transaction is authorized without the customer presenting any man-made tokens such as credit cards, magnetic stripe cards, or smart cards to debit the customer's stored value account and to credit the merchant's account.

### EXAMPLE #7

In another exemplary embodiment, a method for reloading a customer's stored value debit account at the POS uses a biometric-enabled POS terminal as an electronic identity-confirming device and at least one customer candiate biometric information sample. The method comprises the following steps:
Step 1: the customer goes to the biometric-enabled POS terminal, and enters in their UIN, and makes their biometric, such as a fingerprint, available to the POS terminal for scanning. The UIN is transmitted to the NOC.
Step 2: The biometric-enabled POS terminal receives retrieves from the NOC the customer's associated file containing debit, credit, and registered reference biometric information sample template.
Step 3: The registered reference biometric information sample template and the customer's proffered candidate biometric information sample are compared against each other, and thus the customer is authenticated. The account information is displayed and the customer selects their debit account.
Step 4: The POS terminal determines that the debit account has insufficient funds to complete this transaction.
Step 5: Part of the debit account data that is transmitted from the NOC to the POS terminal is information relating to the customer's ability to instantly reload their account. This optional feature requires the customer to have at least one registered credit account. The customer authorizes the payment system operators to present this option to them in the event that their debit account does not have funds to cover a transaction. This option is presented to customer and the customer elects to reload their account for a certain amount.
Step 6: The POS terminal identifies the credit account that the customer has authorized to use as collateral for the funds that will be posted in their debit account while the actual funds are being transferred. Information regarding the selected “collateral credit account” comprise the debit account data that is transmitted to the POS terminal.
Step 7: The POS terminal sends a credit block request to the NOC which switches it to the issuing bank (this already done today, for example, with credit cards at car rentals and hotels). No actual purchase transaction is authorized but the issuing bank does respond whether or not the account has enough credit to have authorized the block. The issuing bank sends a response back to the NOC. The NOC switches the response back to the POS terminal, confirming whether the requested amount has been blocked for that account. If the issuing bank sends a response that the amount could not be blocked, then the POS terminal notifies the customer that their account could not be reloaded and offers the customer the option to conduct a transaction using another financial account.
Step 8: If the POS terminal receives a response that the block was authorized the POS terminal posts the blocked amount to the customer's debit account and authorizes the transaction. The transaction amount is then deducted from the debit account's new balance.
Step 9: The POS terminal sends out a request to the payment system operator's debit processing system that will initiate an ACH transaction from the customer's checking account to the payment system operator's bank account, thus funding the stored value debit account balance.
Step 10: The debit transaction is settled instantly with the NOC or settled at the end of the day.

Thus, a customer's credit lines are used as collateral in instantly allowing them to reload their stored value debit account. The credit lines are not necessarily being used as an alternative method of payment, although that option may be provided. The payment transaction is still a debit transaction, with the collateral credit account being used merely as security during the pendency of the transfer of funds from the customer's checking account into the stored value debit account.

The exemplary embodiments described herein should not be construed as limitations on the scope of the invention, but as exemplifications of the presently preferred embodiments thereof. For example, as will be readily apparent to a person of ordinary skill in the art, it is also possible to replace other tokens now being used in payment authorization systems, such as RFID tags. By way of another example, the embodiments are described with a view towards a single payment processing center/NOC server complex. However, it is within the scope of the invention to have multiple competing or coordinated payment processing centers. Therefore, although the foregoing description contains many specifics, these may not be construed as limiting the scope of the present invention, but merely as providing illustrations of some exemplary embodiments. Other embodiments of the invention may be devised which do not depart from the spirit or scope of the present invention. Features from different embodiments may be employed in combination with one another. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed is:

1. A method for authorizing a debit payment transaction, comprising:
collecting a transaction data and a customer registration data at a point of sale terminal, the customer registration data comprising at least a candidate biometric sample and a unique identifier;
transmitting the unique identifier from the point of sale terminal to a central server;
transmitting a primary reference template and a debit account data from the central server to the point of sale terminal;
determining whether the candidate biometric sample matches the primary reference template;
determining whether the debit payment transaction should be authorized based on predetermined criteria; and
if it is determined that the candidate biometric sample matches the primary reference template and it is determined that the debit payment transaction should be authorized based on predetermined criteria, then authorizing the debit payment transaction.

2. The method according to claim 1, wherein the transaction data comprises a merchant offer and a customer acceptance.

3. The method according to claim 1, wherein the transaction data comprises a transaction amount.

4. The method according to claim 1, wherein the candidate biometric sample comprises fingerprint data.

5. The method according to claim 1, wherein if it is not determined that the candidate biometric sample matches the primary reference template, then the method further comprises:
collecting a secondary candidate biometric sample at the point of sale terminal;
transmitting a secondary reference template from the central server to the point of sale terminal;
determining whether the secondary candidate biometric sample matches the secondary reference template; and
if it is determined that the secondary candidate biometric sample matches the secondary reference template and it is determined that the debit payment transaction should be authorized based on predetermined criteria, then authorizing the debit payment transaction.

6. The method according to claim 1, wherein the debit account data comprises data regarding an available balance in a customer debit account from which the debit payment transaction is to be funded.

7. The method according to claim 6, wherein the customer debit account is a pre-funded stored value account.

8. The method according to claim 1, wherein the step of determining whether the debit payment transaction should be authorized based on predetermined criteria comprises determining whether a customer debit account has sufficient funds available to cover the debit payment transaction.

9. The method according to claim 1, wherein the debit account data comprises data regarding a plurality of customer debit accounts and the method further comprises:
displaying information regarding the plurality of customer debit accounts via the point of sale terminal;
accepting a customer selection via the point of sale terminal of one of the plurality of customer debit accounts from which the debit payment transaction is to be funded; and
using the customer selection in determining whether the debit payment transaction should be authorized based on predetermined criteria.

10. The method according to claim 1, wherein the debit account data comprises data regarding a plurality of customer debit accounts and the method further comprises:
displaying information regarding the plurality of customer debit accounts via the point of sale terminal;
accepting a customer selection via the point of sale terminal of two or more of the plurality of customer debit accounts from which the debit payment transaction is to be funded, the customer selection including the amount of the debit payment transaction that is to be funded from each selected customer debit account; and
using the customer selection in determining whether the debit payment transaction should be authorized based on predetermined criteria.

11. The method according to claim 7, wherein if it is determined that the debit payment transaction should not be authorized due to insufficient funds in the pre-funded stored value account, then the method further comprises:
providing an offer via the point of sale terminal to transfer funds into the pre-funded stored value account from a registered customer checking account;
if the offer is accepted, then requesting the customer to input via the point of sale terminal an amount to be transferred;
issuing a credit block request for the amount to be transferred to an issuing bank of a collateral credit account; and
if the credit block request is confirmed by the issuing bank, then transmitting a request to transfer funds from the registered customer checking account to the pre-funded stored value account and authorizing the debit payment transaction.

12. A method for authorizing a debit payment transaction, comprising:
collecting a transaction data and a customer registration data at a point of sale terminal, the customer registration data comprising at least a candidate biometric sample and a unique identifier;
transmitting the unique identifier from the point of sale terminal to a central server;
transmitting a primary reference template from the central server to the point of sale terminal;
determining whether the candidate biometric sample matches the primary reference template;
if the candidate biometric sample matches the primary reference template, then transmitting a debit account data from the central server to the point of sale terminal;
determining whether the debit payment transaction should be authorized based on predetermined criteria; and
if it is determined that the debit payment transaction should be authorized based on predetermined criteria, then authorizing the debit payment transaction.

13. The method according to claim 12, wherein the transaction data comprises a merchant offer and a customer acceptance.

14. The method according to claim 12, wherein the transaction data comprises a transaction amount.

15. The method according to claim 12, wherein the candidate biometric sample comprises fingerprint data.

16. The method according to claim 12, wherein if it is not determined that the candidate biometric sample matches the primary reference template, then the method further comprises:
collecting a secondary candidate biometric sample at the point of sale terminal;
transmitting a secondary reference template from the central server to the point of sale terminal;
determining whether the secondary candidate biometric sample matches the secondary reference template; and
if it is determined that the secondary candidate biometric sample matches the secondary reference template and it is determined that the debit payment transaction should be authorized based on predetermined criteria, then authorizing the debit payment transaction.

17. The method according to claim 12, wherein the debit account data comprises data regarding available funds in a customer debit account.

18. The method according to claim 17, wherein the customer debit account is a pre-funded stored value account.

19. The method according to claim 12, wherein the step of determining whether the debit payment transaction should be authorized based on predetermined criteria comprises determining whether a customer debit account has sufficient funds available to cover the debit payment transaction.

20. The method according to claim 12, wherein the debit account data comprises data regarding a plurality of customer debit accounts and the method further comprises:
displaying information regarding the plurality of customer debit accounts via the point of sale terminal;
accepting a customer selection via the point of sale terminal of one of the plurality of customer debit accounts from which the debit payment transaction is to be funded; and
using the customer selection in determining whether the debit payment transaction should be authorized based on predetermined criteria.

21. The method according to claim 12, wherein the debit account data comprises data regarding a plurality of customer debit accounts and the method further comprises:
displaying information regarding the plurality of customer debit accounts via the point of sale terminal;
accepting a customer selection via the point of sale terminal of two or more of the plurality of customer debit accounts from which the debit payment transaction is to be funded, the customer selection including the amount of the debit payment transaction that is to be funded from each selected customer debit account; and
using the customer selection in determining whether the debit payment transaction should be authorized based on the transaction data and the debit account data.

22. The method according to claim 18, wherein if it is determined that the debit payment transaction should not be authorized due to insufficient funds in the pre-funded stored value account, then the method further comprises:
providing an offer via the point of sale terminal to transfer funds into the pre-funded stored value account from a registered customer checking account;
if the offer is accepted, then requesting the customer to input via the point of sale terminal an amount to be transferred;
issuing a credit block request for the amount to be transferred to an issuing bank of a collateral credit account;
if the credit block request is confirmed by the issuing bank, then transmitting a request to transfer funds from the registered customer checking account to the pre-funded stored value account and authorizing the debit payment transaction.

23. A method for authorizing a credit payment transaction, comprising:
collecting a transaction data and a customer registration data at a point of sale terminal, the customer registration data comprising at least a candidate biometric sample and a unique identifier;
transmitting the unique identifier from the point of sale terminal to a central server;
transmitting a primary reference template and a credit account data from the central server to the point of sale terminal;
determining whether the candidate biometric sample matches the primary reference template; and
if it is determined that the candidate biometric sample matches the primary reference template, then sending an authenticated authorization request to an issuing bank corresponding to the credit account data.

24. The method according to claim 23, wherein the transaction data comprises a merchant offer and a customer acceptance.

25. The method according to claim 23, wherein the transaction data comprises a transaction amount.

26. The method according to claim 23, wherein the candidate biometric sample comprises fingerprint data.

27. The method according to claim 23, wherein if it is not determined that the candidate biometric sample matches the primary reference template, then the method further comprises:
collecting a secondary candidate biometric sample at the point of sale terminal;
transmitting a secondary reference template from the central server to the point of sale terminal;
determining whether the secondary candidate biometric sample matches the secondary reference template; and
if it is determined that the secondary candidate biometric sample matches the secondary reference template, then sending an authenticated authorization request to an issuing bank corresponding to the credit account data.

28. The method according to claim 23, wherein the credit account data comprises data regarding a registered customer credit account.

29. The method according to claim 28, wherein the registered customer credit account is a VISA®, MASTERCARD®, or DISCOVER® account.

30. The method according to claim 23, wherein the credit account data comprises data regarding a plurality of registered customer credit accounts and the method further comprises:
displaying information regarding the plurality of registered customer credit accounts via the point of sale terminal;
accepting a customer selection via the point of sale terminal of one of the plurality of registered customer credit accounts from which the credit payment transaction is to be funded; and
using the customer selection in sending the authenticated authorization request to the issuing bank corresponding to the selected customer credit account.

31. The method according to claim 23, wherein the credit account data comprises data regarding a plurality of registered customer credit accounts and the method further comprises:
displaying information regarding the plurality of registered customer credit accounts via the point of sale terminal;
accepting a customer selection via the point of sale terminal of two or more of the plurality of registered customer credit accounts from which the credit payment transaction is to be funded, the customer selection including a amount of the credit payment transaction to be funded from each selected registered customer credit account; and
using the customer selection in sending the authenticated authorization request to the issuing bank for each selected registered customer credit account.

32. A method for authorizing a debit payment transaction, comprising:
collecting a transaction data and a customer registration data at a point of sale terminal, the customer registration data comprising at least a candidate biometric sample and a unique identifier;
transmitting the unique identifier from the point of sale terminal to a central server;
transmitting a primary reference template and a debit account data from the central server to the point of sale terminal, the debit account data comprising data regarding available funds in a pre-funded stored value account from which the debit payment transaction is to be funded;
determining whether the candidate biometric sample matches the primary reference template;
determining whether the debit payment transaction should be authorized based on predetermined criteria;
if it is determined that the candidate biometric sample matches the primary reference template and it is determined that the debit payment transaction should not be authorized due to insufficient funds in the pre-funded stored value account, then providing an offer via the point of sale terminal to transfer funds into the pre-funded stored value account from a registered customer checking account;
if the offer is accepted, then requesting the customer to input via the point of sale terminal an amount to be transferred;
issuing a credit block request for the amount to be transferred to an issuing bank of a collateral credit account; and
if the credit block request is confirmed by the issuing bank, then transmitting a request to transfer funds from the registered customer checking account to the pre-funded stored value account and authorizing the debit payment transaction.
